(19) United States
(12) Patent Application Publication
(10) Pub. No.: US 2011/0259657 A1
(43) Pub. Date: Oct. 27, 2011

(54) VEHICLE HAVING ELECTRIC DRIVE

(75) Inventor: Martin Fuechtner, Stuttgart (DE)

(73) Assignee: DR. ING. H.C.F. PORSCHE AKTIENGESELLSCHAFT, Stuttgart (DE)

(21) Appl. No.: 13/093,293

(22) Filed: Apr. 25, 2011

(30) Foreign Application Priority Data
Apr. 23, 2010 (DE) 10 2010 017 966.3

(51) Int. Cl. B60K 6/20; B60K 1/02; B60K 1/00

(52) U.S. Cl. 180/65.21; 180/65.1; 180/65.6; 903/902

(57) ABSTRACT

Different axle arrangements are provided for a hybrid vehicle or a vehicle that can be driven exclusively by an electric machine. The vehicle has a front and rear axles and at least one drive that comprises an electric machine for driving at least one wheel of one of the axles.

### CROSS REFERENCE TO RELATED APPLICATION

This application claims priority under 35 USC 119 to German Patent Application No 10 2010 017 966.3 filed on Apr. 23, 2010, the entire disclosure of which is incorporated herein by reference.

### BACKGROUND OF THE INVENTION

1. Field of the Invention

The invention relates to a vehicle with an electric drive.

2. Description of the Related Art

Some vehicles, such as passenger cars, can be driven exclusively electrically by an electric machine. Other vehicles, namely hybrid vehicles, are equipped with both an electric machine and a non-electric drive, such as an internal combustion engine. The internal combustion engine can charge an energy store, in particular an electric energy store, such as a vehicle battery (serial hybrid) and/or can be coupled mechanically to a drive shaft (parallel hybrid). The electric machine is used as a generator while braking the vehicle and charges the energy store to lower fuel or energy consumption of the hybrid vehicle. The electric machine therefore acts as an electro-motive brake and regenerates energy. Additionally or alternatively, the electric machine can be operated as a motor. As a result, an additional electric drive (boosting) is possible in addition to the driving the hybrid vehicle by the internal combustion engine. Driving exclusively with the electric machine also is possible, for example over short distances with emission restrictions.

The object of the invention is to disclose different axle concepts for a vehicle that can be driven exclusively by an electric machine or is embodied as a hybrid vehicle.

### SUMMARY OF THE INVENTION

The invention provides a vehicle having front and rear axles and at least one drive that has an electric machine for driving at least one wheel of one of the axles. The vehicle also can have a non-electric drive, such as an internal combustion engine.

The drive, which may only be the electric machine or the hybrid drive, can be arranged in front of or behind the axle assigned to the drive. The hybrid drive is formed by an electric machine and a non-electric drive, in particular an internal combustion engine.

The drive can drive one wheel or all wheels of the axle. In particular if the drive is provided exclusively by the electric machine, the drive concept of the drive of a wheel can be implemented by means of the drive.

The electric machine can be a direct drive or a cardan shaft that connects the electric machine and the wheel. The direct drive may be a short shaft between the electric machine and the wheel or the electric machine may be a wheel hub motor.

Torque can be transmitted from the drive to the wheel or wheels of the axle in different ways, such as by using an angular gear, a differential gear, a spur gear or a planetary gear, if appropriate in combination with different gears.

Spatial conditions are taken into account in the region of the axle. Thus, the axle may be a portal axle oriented in any desired way, depending on the spatial conditions. The portal therefore can be directed up, down, forward or rearward with respect to the orientation of the vehicle or the forward travel direction.

Each axle can be assigned an electric machine, and the torque of this electric machine is transmitted to the two wheels of this axle with the intermediate connection of a transmission. On the other hand, two electric machines can be assigned to each axle. In this case, the respective electric machine drives a wheel assigned thereto, and both wheels of the axle can be driven by a cardan shaft and a differential gear assigned thereto.

The drive of the wheels of the axle can be provided exclusively electrically by at least one electric machine. In this case, the electric machine may be arranged in the longitudinal direction or in the transverse direction of the vehicle.

The drive of the wheels can be provided by at least one electric machine and also non-electrically by an internal combustion engine. In this case, the electric machine also can be arranged in the longitudinal direction or the transverse direction of the vehicle.

The arrangement of the electric machine in the longitudinal or transverse direction of the vehicle depends on spatial conditions for installing the electric machine.

At least one clutch can be arranged in the drive train of the electric machine and/or of the non-electric drive for the wheel or the wheels of the axle. The clutch may be, for example, a mechanical clutch or a viscous clutch (for example a hang-on clutch). The clutch may be arranged in the drive train between the non-electric drive and the electric machine or between the electric machine and the wheel or wheels assigned thereto.

The non-electric drive, in particular the internal combustion engine, preferably drives the wheels of the axle via a shaft arranged longitudinally along the longitudinal axis of the vehicle. The electric machine may be parallel to the shaft and off center or may be arranged in the transverse direction of the vehicle.

When the hybrid concept is implemented, the internal combustion engine can be at the front, at the rear or in the center of the vehicle. Thus, the vehicle can have a front-mounted engine, a rear-mounted engine or a center-mounted engine.

The following drawing illustrates preferred axle concepts using a purely electric drive or a hybrid drive in a highly simplified form.

### BRIEF DESCRIPTION OF THE DRAWINGS

FIGS. 1 to 4 illustrate four different axle arrangements in an electric machine installed longitudinally, without a mechanical drive.

FIGS. 2.1 to 2.8 show eight different axle embodiments for an electric machine installed longitudinally with an additional mechanical drive.

FIGS. 3.1 to 3.14 show fourteen different axle embodiments for an electric machine installed transversely without a mechanical drive.

FIGS. 4.1 to 4.12 show twelve different axle embodiments for an electric machine installed transversely with an additional mechanical drive.

### DETAILED DESCRIPTION OF THE PREFERRED EMBODIMENTS

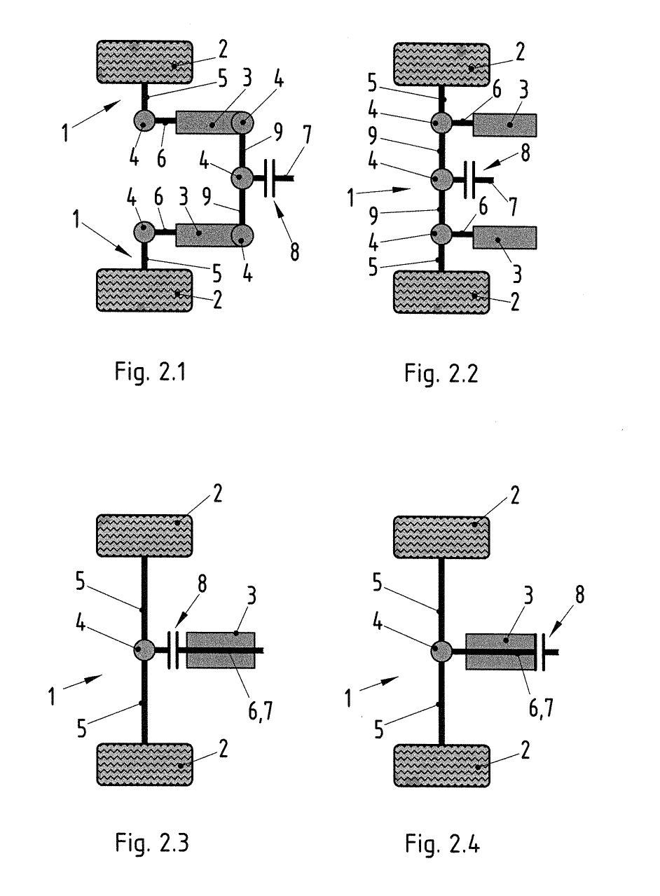

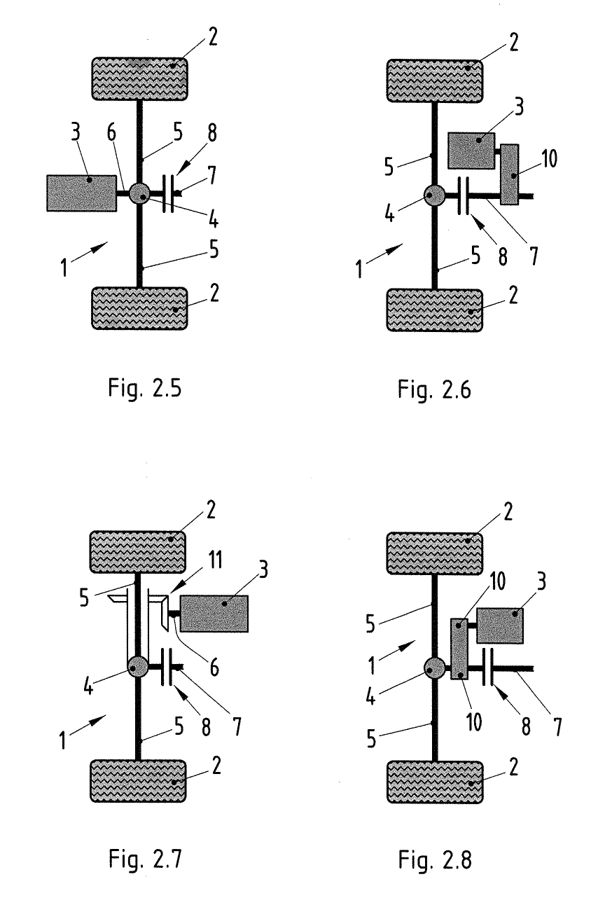

The variants illustrated are used, in particular, in a vehicle that has all wheel drive. The second axle in each case preferably is driven by an internal combustion engine, which, in the embodiments FIGS. 2.1 to 2.8 and 4.1 to 4.12, additionally drives the other axle, which can be driven by the electric machine. It should be noted that, for simplicity, the same reference numeral are used throughout to identify functionally components. Thus, the reference numeral 1 is used to denote and axle in each embodiment, the reference numeral 2 denotes wheels, the reference numeral 3 denotes electric machines and the reference numeral 4 is used to generically denote transmissions. The transmissions 4 can take many forms, such as an angular gear, a differential gear, a spur gear or a planetary gear, and combinations of such different transmissions can be used in any of the embodiments described herein.

1. Electric Machine in a Longitudinal Arrangement, without Mechanical all Wheel Drive

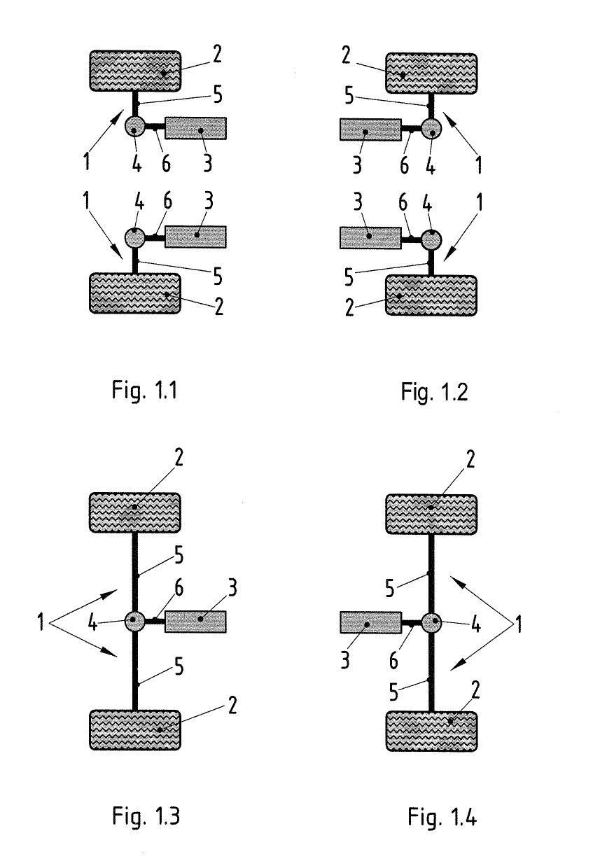

FIGS. 1.1 and 1.2 show axle embodiments with two electric machines, and FIGS. 1.3 and 1.4 show axle embodiments with an electric machine.

FIG. 1.1 shows a front axle 1 of a passenger car. The axle 1 has two wheels 2. The arrangement is illustrated in plan view and the forward direction of travel of the vehicle is from right to left in the illustration. These details relating to axle 1, wheel 2 and the orientation of the vehicle also apply to the description of the following figures.

The embodiment of FIG. 1.1 has two electric machines 3 arranged in the longitudinal direction of the vehicle and positioned behind the axle 1. Each machine 3 functions to drive a wheel. The machines are parallel to one another and are positioned adjacent the assigned wheel 2. The respective electric machine 3 is coupled to a transmission 4, such as an angular gear, and drives a cardan shaft 5 arranged in the axial direction and connected to the wheel 2 assigned thereto. The respective axle 1 also can be the rear axle of the vehicle.

An output shaft 6 of the electric machine 3 drives, via a transmission 4 which is embodied as an angular gear, a cardan shaft 5 that is arranged in the transverse direction of the vehicle and is connected to the wheel 2. The electric machine 3 is behind the axle 1.

2. Electric Machine in a Longitudinal Arrangement, with Mechanical all Wheel Drive

The embodiment of FIG. 1.2 differs from FIG. 1.1 in that the two electric machines 3 are arranged in front of the axle 1.

In the embodiment of FIG. 1.3, just one electric machine 3 is provided. The electric machine 3 drives, via a transmission 4, which is embodied as a differential gear, two cardan shafts 5 that are connected respectively to the two wheels 2.

The embodiment of FIG. 1.4 differs from FIG. 1.3 in that the electric machine 3 is arranged in front of the axle 1.

FIGS. 2.1 and 2.2 show axle embodiments of two electric machines, the axle embodiments in FIGS. 2.3 to 2.8 have one electric machine.

The embodiment of FIG. 2.1 is based on the embodiment of FIG. 1.1. However, in the embodiment of FIG. 2.1, the mechanical drive, in particular the output shaft 7 of a transmission, is connected downstream of an internal combustion engine and interacts with a clutch 8. The clutch 8 is connected on the output side to a transmission 4, which is embodied as a differential gear and from which two transverse shafts 9 extend. The transverse shafts 9 interact with the output shafts 6 of the two electric machines 3 via transmissions 4 assigned thereto. These transmissions 4 are embodied as angular gears. The axle 1 can be driven exclusively electrically when the clutch 8 is opened. When the clutch 8 is closed, the axle 1 can be driven exclusively mechanically or as a hybrid, depending on whether the electric machines 3 are operating.

The embodiment of FIG. 2.1 has a portal axle which, according to FIG. 2.1, is oriented toward the rear. The portal axle also can be arranged symmetrically with respect to the axle 1, that is to say can be oriented towards the front, or can be oriented perpendicularly to the plane of the drawing in the up or down direction. The orientation depends on the space conditions in the region of the axle.

The embodiment of FIG. 2.2 differs from FIG. 2.1 in that the force flux from the internal combustion engine via the clutch 7 does not pass via the electric machines 3 but rather the transmission 4, which is located in the force flux directly behind the clutch 8. The transmission 4 is a differential gear that interacts directly, via the transverse shaft 9 assigned to this transmission 4, with the angular gears 4 with which the output shafts 6 of the electric machines 3 also interact

According to the embodiment of FIG. 2.3, the output shaft 6 of the electric machine 3, which at the same time constitutes the output shaft 7 of the internal combustion engine, is connected via the clutch 8 to the transmission 4, which is embodied as a differential gear. The differential gear 4 is connected via the cardan shafts 5 to the wheels 2, as shown with respect to the concept according to FIG. 1.3. The clutch 8 is embodied, for example, as a hang-on clutch.

The embodiment of FIG. 2.4 differs from FIG. 2.3 in that the clutch 8 is not arranged behind the electric machine 3 but rather in front of the electric machine 3 with respect to the drive direction. Purely electro-motive drive of the axle 1 is possible when the clutch 8 is opened.

The electric machine 3 is arranged in front of the axle 1 in the embodiment of FIG. 2.5, and the clutch 8 is between the axle and the internal combustion engine, behind the axle 1. The vehicle can be operated purely electrically when the clutch 8 is opened.

In the axle embodiment of FIG. 2.6, the output shaft 7 of the transmission assigned to the internal combustion engine is connected via the clutch 8 to the differential gear 4, which drives the wheels 2 via the cardan shafts 5. In the torque flux upstream of the clutch 8, the output shaft 7 interacts with a connecting element 10, which in turn interacts with the output shaft 6 of the electric machine 3. The electric machine 3 is arranged parallel to the output shaft 7. The connecting element 10 can be configured in different ways, for example as a spur gear, chain drive or the like. In this embodiment, the clutch 8, the electric machine 3 and the connecting element 10 are arranged on the side of the axle 1 facing the internal combustion engine, in particular behind the axle 1.

An asymmetrical arrangement of the electric machine 3 generally is advantageous if sufficient space for accommodating the electric machine 3 is present only in the region of a wheel 2.

The axle embodiment of FIG. 2.7 is oriented similar to the embodiment of FIG. 2.5. However, the electric machine 3 is arranged on the side of the axle 1 on which the clutch 8 is located, and is arranged off center with respect to the output shaft 7. The output shaft 6 of the electric machine 3 interacts via a bevel gear 11 with the differential gear 4 that acts on the cardan shafts 5.

The embodiment of FIG. 2.8 corresponds essentially to FIG. 2.6 with the difference that the connecting element 10 does not interact with the output shaft 7, with respect to the application of torque upstream of the clutch 8, but rather is arranged behind the clutch 8 and directly in front of the differential gear 4. Thus, in the embodiment of FIG. 2.8, the axle 1 can be driven purely electrically when the clutch 8 is opened.

3. Electric Machine in a Transverse Arrangement, without Mechanical all Wheel Drive

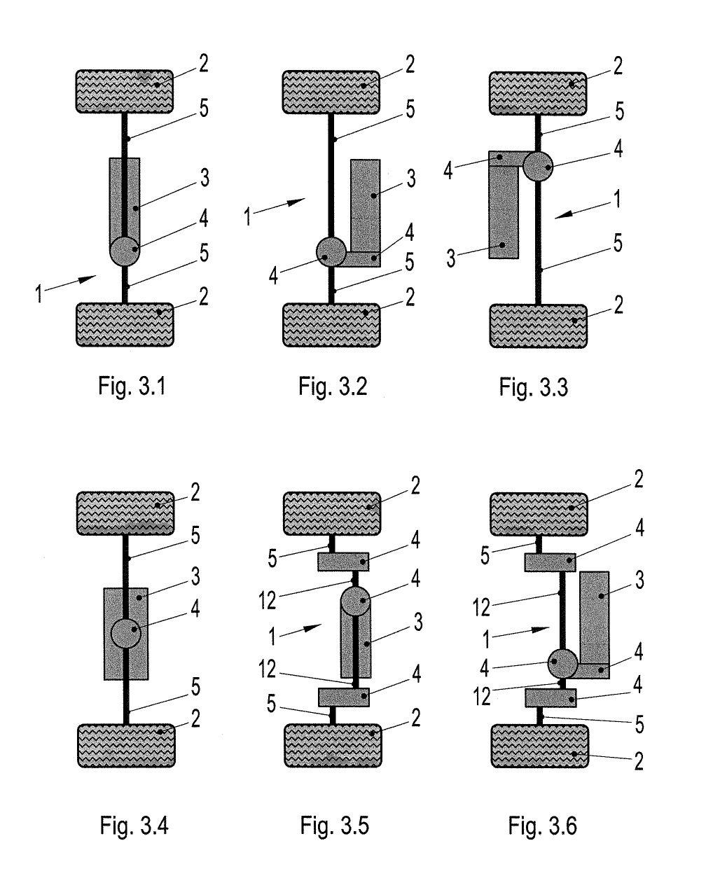

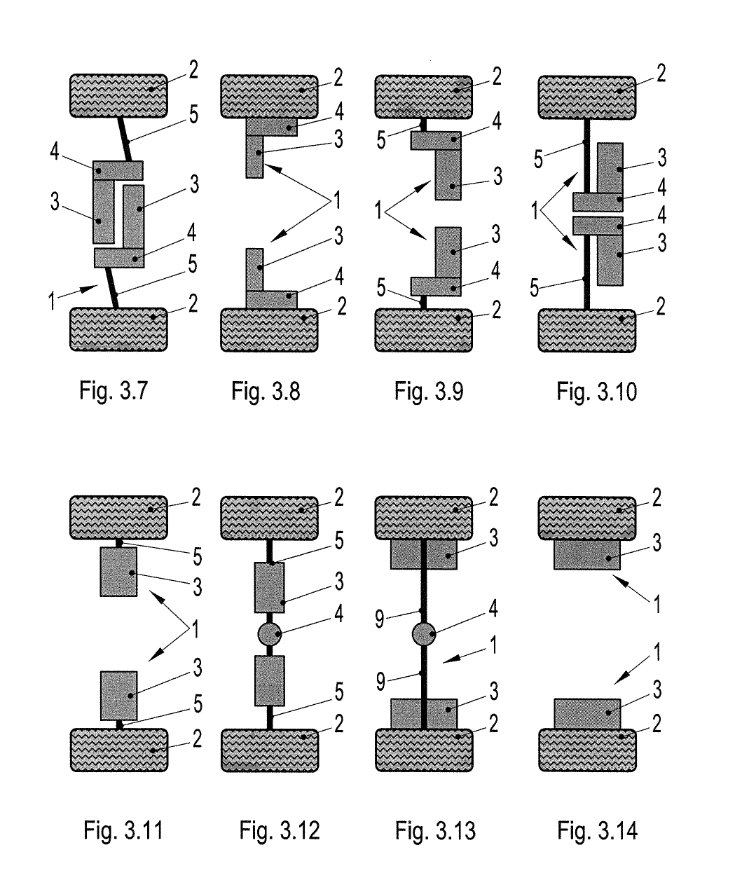

FIGS. 3.1 to 3.6 show one electric machine 3 used for various embodiments. FIGS. 3.7 to 3.14 show the use of two electric machines 3 for the different embodiments.

The electric machine 3 of FIG. 3.1 is arranged coaxially to the axle 1 or the cardan shafts 5. The electric machine 3 comprises a transmission which is connected, via a further transmission 4, which is a differential gear, to the cardan shafts 5. The transmission of the electric machine 3 can be a planetary gear or a spur gear.

The axle embodiment of FIG. 3.2 differs from FIG. 3.1 in that the electric machine is not coaxial with the axle 1 or the cardan shafts 5. The torque is transmitted to the differential gear 4, which interacts with the two cardan shafts 5, via a transmission 4 of the electric machine 3. In FIG. 3.2, the electric machine 3 is shown behind the axle 1. However, it could be arranged equally well in front of, below or above the axle 1.

The embodiment of FIG. 3.3 differs from FIG. 3.2 in that the off center differential gear 4, which is connected to the two cardan shafts 5, is closer to the opposite wheel 2 than in FIG. 3.2 and in that the electric machine 3 is in front of the axle 1.

In the embodiment of FIG. 3.4, the electric machine 3 is above the differential gear 4, and the electric machine 3 has a transmission, for example a spur gear or a planetary gear, for transmitting the movement of the rotor of the electric machine 3 to the differential gear 4.

The embodiment of FIG. 3.5 differs from FIG. 3.1 in that the cardan shafts 5 are not continuous starting from the differential gear 4, but rather the axle is a portal axle. Accordingly each wheel 2 has an additional transmission, in particular a spur gear 4.

The embodiment of FIG. 3.6 differs from FIG. 3.5 in that the electric machine 3 is not coaxial to the shafts 12, and a further transmission, in particular a spur gear 4, is provided for transmitting the movement of the electric machine 3 to the differential gear 4 which is connected to the two drive shafts 12 and then to transmission gears 4. The embodiment of FIG. 3.6 also relates to a portal axle concept.

Two electric machines 3 are arranged next to one another in the embodiment of FIG. 3.7 or one above the other. Opposite ends of the electric machines 3 are connected via transmissions 4, in particular a spur gear and/or planetary gear, to the cardan shaft 5 that connects to the assigned wheel 2.

The embodiment of FIG. 3.8 has no axle shaft, but rather an electric machine 3 is assigned to the respective wheel 2 and drives the assigned wheel via a transmission 4, in particular a spur gear and/or a planetary gear. In this concept, the respective electric machine 3 and/or the associated transmission 4 is mounted in the chassis of the vehicle. The electric machines 3 are arranged in front of the rotational axis of the wheels 2.

The embodiment of FIG. 3.9 has two electric machines 3 arranged one behind the other in the transverse direction of the vehicle. Each machine 3 is connected to the wheel 2 via a transmission 4, in particular a spur gear and/or planetary gear and a cardan shaft 5 that extends from this transmission 4. There is no continuous drive shaft.

The embodiment of FIG. 3.10 differs from FIG. 3.9 in that the cardan shafts 5 are substantially longer and the transmissions 4 are arranged between the ends of the cardan shafts 5. The electric machines 3 are located next to the cardan shafts 5.

Each electric machine 3 in the embodiment of FIG. 3.11 is concentric to the short cardan shaft 5, and in the direct vicinity of the wheel 2. Thus, the short cardan shaft 5 connects the respective electric machine 3 to the associated wheel 2.

The embodiment of FIG. 3.12 has two electric machines 3 connected to the respective wheels 2 via cardan shafts 5. The electric machines 3 are connected by transverse shafts 9 and the differential gear 4 assigned to the transverse shafts 9 and which is, for example, a lockable differential gear.

The electric machines 3 in the embodiment of FIG. 3.13 are wheel hub motors that are connected to the wheels 2. The output shafts of the electric machines 3 are connected by connecting shafts 9, and a transmission 4, which is a differential gear assigned to the connecting shafts 9 to eliminate fraction problems.

FIG. 3.14 shows an axle embodiment that is further simplified compared to FIG. 3.13 by virtue of the fact that only two electric machines 3, which engage directly on the wheels 2 and which are embodied as wheel hub motors, are provided.

4. Electric Machine in a Transverse Arrangement, with Mechanical all Wheel Drive

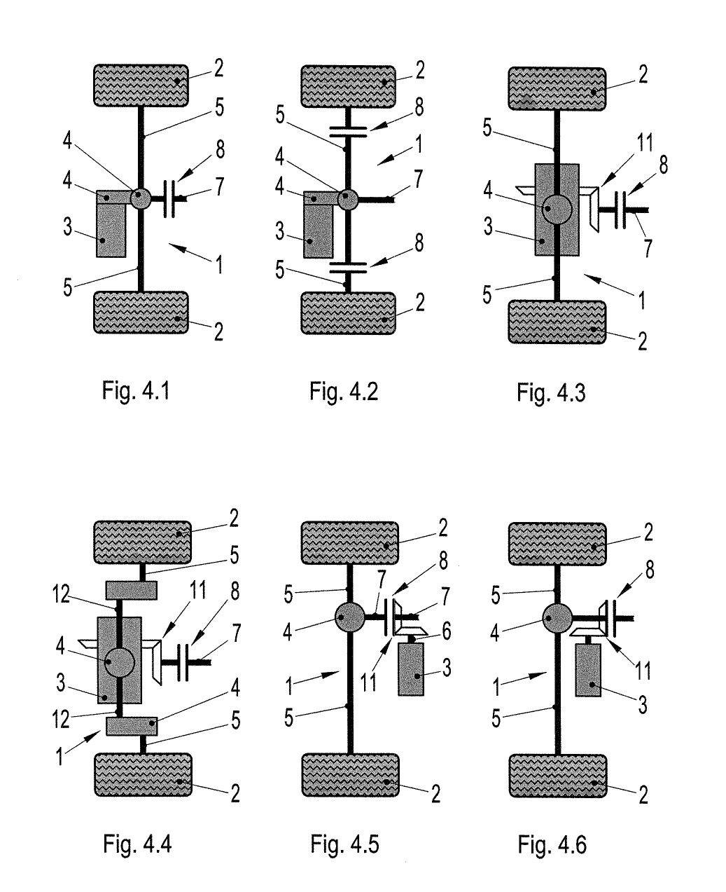

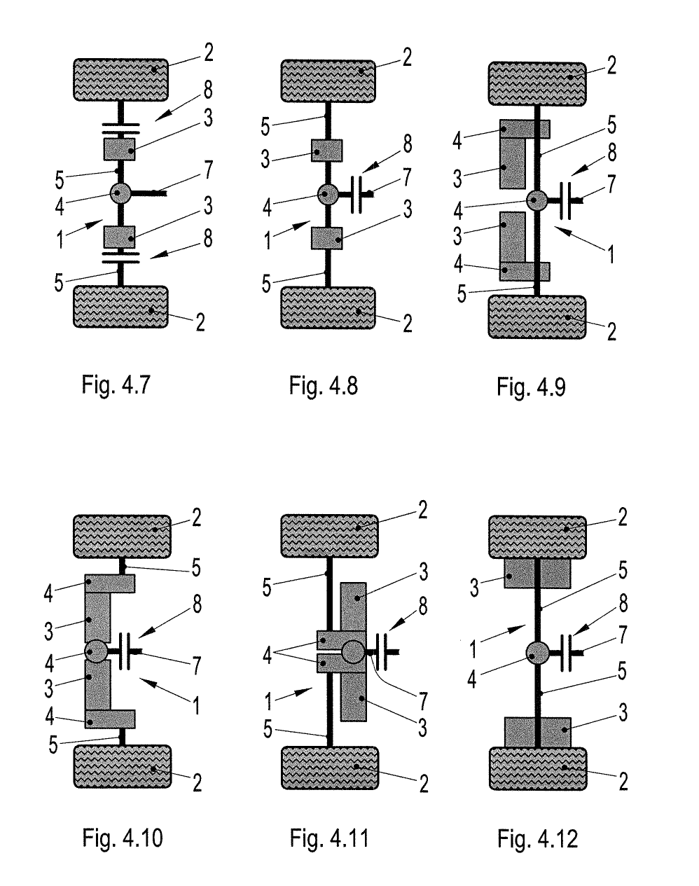

FIGS. 4.1 to 4.6 illustrate various embodiments using one electric machine, and FIGS. 4.7 to 4.12 illustrate various embodiments using two electric machines.

FIG. 4.1 shows an axle embodiment similar to FIG. 2.5, but the electric machine 3 is located in front of and parallel to the axle 1. The electric machine 3 is connected via a transmission 4, in particular a spur gear and/or a planetary gear, to the differential gear 4 which is connected to the two cardan shafts 5. A clutch could be provided in the drive train of the electric machine 3 with respect to the differential gear 4 so that that the vehicle can be operated as an all wheel drive exclusively by the internal combustion engine when the motor-side clutch 8 is closed.

The connection of the electric machine 3 to the differential gear 4 in FIG. 4.2 is similar to the drive arrangement of FIG. 4.1. However, no clutch is assigned to the output shaft 7 but rather a clutches 8 are assigned to the respective cardan shafts 5.

The embodiment of FIG. 4.3 is similar to FIG. 3.4. However, torque is applied to the cardan shafts 5 via a bevel gear 11 and the drive train of the internal combustion engine, that is to say the output shaft 7 with the clutch 8.

The axle embodiment of FIG. 4.4 is similar to FIG. 4.3, but employs a portal axle with appropriate gears, such as spur gears 4.

The axle embodiment of FIG. 4.5 has a clutch 8 assigned to the output shaft 7 of the transmission of the internal combustion engine. The clutch 8 interacts on the output side with the differential gear 4, which is connected by the cardan shafts 5 to the wheels 2. This transmission 4 is off center with respect to the longitudinal axis of the vehicle. On the side of the clutch facing the internal combustion engine, the transversely located electric machine interacts with the output shaft 7 via a bevel gear 11. The electric machine is arranged symmetrically with respect to the longitudinal center axis of the vehicle.

The axle embodiment of FIG. 4.6 differs from FIG. 4.5 as a result of the fact that the bevel gear 11 acts on the output shaft 7 between the clutch and the differential gear 4. Therefore, when the clutch is opened, the vehicle can be operated purely electrically.

The axle embodiment of FIG. 4.7 shows electric machines 3 arranged between the differential gear 4 and the assigned wheels 2 and then clutches 8 between the electric machines 3 and the assigned wheels 2. An output shaft 7 of the transmission of the internal combustion engine interacts with the differential gear 4.

FIG. 4.8 differs from FIG. 4.7 in that the two clutches 8 assigned to the cardan shafts 5 of FIG. 4.7 are eliminated. Instead a clutch 8 is provided in FIG. 4.8 between the transmission of the internal combustion engine and the differential gear 4, adjacent to the differential gear 4.

FIG. 4.9 differs from FIG. 4.8 in that the electric machines 3 are not arranged coaxially with respect to the cardan shafts 5, but rather are spaced from the cardan shafts 5 and parallel thereto. Each respective electric machine 3 is connected to the assigned cardan shaft 5 via a transmission 4, such as a spur gear and/or planetary gear.

The axle embodiment of FIG. 4.10 is similar to FIG. 4.8, but employs a portal axle. Accordingly, the torque is applied via the differential gear 4 to the respective electric machine 3 assigned thereto, and is applied from there to the cardan shaft 5 via the transmission 4, which is embodied as a spur gear and/or planetary gear.

The axial embodiment of FIG. 4.11 has two transmissions 4, which are embodied as a spur gear and/or planetary gear, connected to the two electric machines 3 and the two cardan shafts 5. A transmission 4, which is embodied as a differential gear, also is assigned to the two electric machines 3. Torque of an internal combustion engine can be introduced via the output shaft 7 to the differential gear 4. A clutch 8 is assigned to the output shaft 7.

The axle embodiment of FIG. 4.12 is similar to FIG. 3.13, with the difference that the output shaft 7, to which a clutch 8 is assigned, also interacts with the differential gear 4.

What is claimed is:

1. A vehicle comprising: at least one axle having wheels and at least one drive that has an electric machine for driving at least one wheel of one of the axles.

2. The vehicle of claim 1, wherein the drive further comprises a nonelectric drive.

3. The vehicle of claim 2, wherein the drive is in front of, behind, above or below the axle assigned to the drive.

4. The vehicle of claim 1, wherein the drive drives a plurality of the wheels of the axle.

5. The vehicle of claim 1, further comprising an angular gear, a differential gear, a spur gear or a planetary gear disposed for driving at least one of the wheels of the axle.

6. The vehicle of claim 1, wherein the electric machine drives the respective wheel directly or by a cardan shaft that connects the electric machine and the wheel.

7. The vehicle of claim 1, wherein the axle is a portal axle with upward, downward, forward or rearward orientation.

8. The vehicle of claim 1, wherein each axle is assigned one or two electric machines.

9. The vehicle of claim 1, wherein the wheels of one axle are driven by cardan shafts and a differential gear assigned thereto.

10. The vehicle of claim 1, wherein the drive of the wheels of the axle is provided exclusively electrically by the at least one electric machine, and the electric machine is arranged in a longitudinal or transverse direction of the vehicle.

11. The vehicle of claim 1, wherein the drive of the wheels of the axle is provided electrically by the at least one electric machine and non-electrically by a non-electric drive, the electric machine being arranged in a longitudinal or transverse direction of the vehicle.

12. The vehicle of claim 11, wherein at least one clutch is arranged in the drive train of the electric machine or of the non-electric drive for the at least one wheel of the axle.

13. The vehicle of claim 12, wherein the clutch in the drive train is arranged between the non-electric drive and the electric machine.

14. The vehicle of claim 2, wherein the non-electric drive drives a shaft arranged longitudinally and centrally with respect to the vehicle, and the electric machine is arranged parallel to the shaft and off center or is arranged in the transverse direction of the vehicle.

15. The vehicle of claim 2, wherein the nonelectric drive is a front mounted internal combustion engine, a rear-mounted internal combustion engine or a center-mounted internal combustion engine.
